(19) United States
(12) Patent Application Publication
(10) Pub. No.: US 2008/0183437 A1
(43) Pub. Date: Jul. 31, 2008

(54) Simulation method, medium and apparatus

(75) Inventors: Young-ihn Kho, Seoul (KR); Jong-keun Cho, Assan-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/007,125

(22) Filed: Jan. 7, 2008

(30) Foreign Application Priority Data
Jan. 30, 2007 (KR) 10-2007-0009636

(51) Int. Cl. G06F 17/50

(52) U.S. Cl. 703/1

(57) ABSTRACT

A simulation method, medium and apparatus, in which objects to be simulated are simulated at various precisions that are selectable according to an environmental context, thereby efficiently using computing resources for simulation.

### CROSS-REFERENCE TO RELATED APPLICATIONS

This application claims the benefit of Korean Patent Application No. 10-2007-0009636, filed on Jan. 30, 2007, in the Korean Intellectual Property Office, the disclosure of which is incorporated herein in their entirety by reference.

### BACKGROUND

1. Field

One or more embodiments of the present invention relate to simulation, and more particularly, to a simulation method, medium and apparatus, in which each object in a displayed image is simulated in order to update the displayed image according to a user's key manipulation result, as in a computer game.

2. Description of the Related Art

Generally, an image provided to a user who is playing a computer game is a moving image that is updated according to a user's key manipulation result. A frame at a particular point of time may include a plurality of objects. For example, in a 3-dimensional (3D) racing game, a frame at a specific point of time may include a plurality of objects representing a racing car.

In order to update an image expressed by a frame at a specific point of time according to a user's key manipulation result, each object included in the frame has to be simulated based on the key manipulation result. A conventional simulation apparatus that performs such a simulation simulates all objects with the same precision. In other words, the conventional simulation apparatus simulates both “an object whose simulation result is of relatively great interest to the user” and “an object whose simulation result is of relatively little interest to the user” with the same precision. For the object whose simulation result is of relatively little interest to the user, the user is not likely to be dissatisfied with the simulation result even if the simulation result is inaccurate. Conversely, for the object whose simulation result is of relatively great interest to the user, the user is likely to be dissatisfied with the simulation result if it is even slightly inaccurate. For example, a user who concentrates on racing in a 3D racing game may be more interested in the simulation result for an object representing a racing car rather than in a simulation result for an object representing a stone on a track. Thus, high precision is not required for the simulation result with respect to the stone, in contrast with the simulation result with respect to the car. However, a conventional simulation apparatus simulates the stone and the car with the same precision.

As a result, the conventional simulation apparatus inefficiently uses computing resources for simulation.

### SUMMARY

One or more embodiments of the present invention provide a simulation method, in which objects to be simulated are simulated at various precisions, thereby efficiently using computing resources for simulation.

One or more embodiments of the present invention also provide a simulation apparatus which simulates objects to be simulated at various precisions, thereby efficiently using computing resources for simulation.

One or more embodiments of the present invention also provide a computer-readable recording medium having stored thereon a computer program for simulating objects to be simulated at various precisions, thereby more efficiently using computing resources for simulation.

Additional aspects and/or advantages will be set forth in part in the description which follows and, in part, will be apparent from the description, or may be learned by practice of the invention.

To achieve at least the above and/or other aspects and advantages, embodiments of the present invention include a simulation method including, identifying a simulation precision of an object selectively based on a determined environmental context of the object and a simulation preset of the object, and simulating the object with the identified precision.

To achieve at least the above and/or other aspects and advantages, embodiments of the present invention include a simulation apparatus including, a precision recognition unit to identify a simulation precision of an object selectively based on a determined environmental context of the object and a simulation preset of the object, and a simulation unit to simulate the object with the identified precision.

To achieve at least the above and/or other aspects and advantages, embodiments of the present invention include an apparatus simulating objects in an image, the apparatus including, a precision recognition unit to identify a desired simulation precision of an object in the image from a plurality of predetermined simulation precisions based on an environmental context of the object, and a simulation unit to simulate the object with a precision identified by the precision recognition unit.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram of a simulation apparatus according to the present invention; and

FIG. 2 is a flowchart of a simulation method according to the present invention.

### DETAILED DESCRIPTION OF EMBODIMENTS

Reference will now be made in detail to embodiments, examples of which are illustrated in the accompanying drawings, wherein like reference numerals refer to the like elements throughout. Embodiments are described below to explain the present invention by referring to the figures.

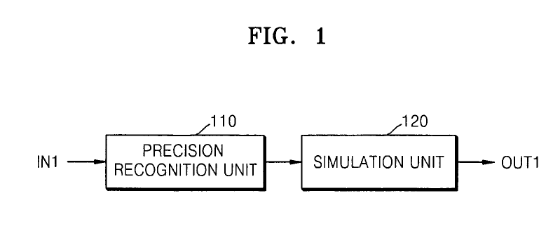

FIG. 1 illustrates a simulation apparatus, according to an embodiment the present invention. Referring to FIG. 1, the simulation apparatus may include, for example a precision recognition unit 110 and a simulation unit 120.

The precision recognition unit 110 may recognize, i.e., identify, the simulation precision of each of at least one object included in an image input through an input terminal IN1 (hereinafter, “simulation precision” is simply referred to as “precision” for convenience). The image typically denotes an image expressed by a frame at a specific point of time, i.e., time=tₒ (where tₒ is a positive integer) in a moving image updated according to a user's key manipulation result. In an embodiment it is preferable that the specific point of time is a time at which the simulation apparatus, according to the present invention, is instructed to perform simulation. The moving image may be, for example, a moving image provided to a user who is playing a computer game. The specific point of time may be, for example, a point of time at which an input device required for playing the computer game, e.g., a keyboard, a mouse, a joy-stick, or the like, is manipulated.

A precision of an object may be a value that is determined based on a simulation environment, i.e., an environmental context, at a specific point of time or that is preset by the user. More specifically, if the precision of an object to be simulated is preset, the precision recognition unit 110 may recognize the preset precision as the precision of the object. However, if the precision is not preset, the precision recognition unit 110 may determine the precision of the object based on a simulation environment, i.e., environmental context, at the specific point of time and recognize the determined precision as the precision of the object. The determined precision may be, for example, a desired or optimum precision based on the environmental context and the desired computing efficiency.

For example, the environmental context may be “a distance between the object to be simulated and a viewpoint” or “whether or not the object to be simulated is within sight of the viewpoint”. The object to be simulated typically means an object included in the image input through the input terminal IN1.

Typically, as the distance between the object to be simulated and the viewpoint increases, the precision of the object may be set lower. If the object to be simulated is within sight of the viewpoint, the precision of the object may be set higher. To this end, in an embodiment it is preferable that the simulation apparatus according to the present invention has a look-up table in which precisions are predetermined according to “whether or not the object to be simulated is within the sight of the viewpoint” and “the distance between the object to be simulated and the viewpoint”. In this case, the precision recognition unit 110 may search a corresponding precision in the look-up table based on both “whether or not the object to be simulated is within the sight of the viewpoint” and “the distance between the object to be simulated and the viewpoint”, and may determine the located precision as the precision of the object to be simulated.

The simulation unit 120 may simulate the object to be simulated using information about the object and may output the simulation result through an output terminal such as OUT1. In other words, the simulation unit 120 may simulate the object at another point of time, e.g., time=tₒ+h (where h is a positive integer) using information about the object at the specific point of time, i.e., time=tₒ. The position and shape of the object may be changed over time, but it may be assumed that the object is a rigid body, that is for convenience of explanation, only the position of the object and not the shape may be changed over time in this case.

A relationship between the position of the object at another point of time (time=tₒ+h) and the position of the object at the specific point of time (time=tₒ) may be expressed, for example in Equation 1, using Taylor Series as follows:

Equation 1:

x(to+h)=x(to)+h*x′(to)+(h²/2!)*x″(to)+(h³/3!)*x′″(to)+ . . . +(hⁿ/n!)*x⁽ⁿ⁾(to)+(1),

where x(tₒ+h) indicates the position of the object to be simulated at another point of time (time=tₒ+h), x(tₒ) indicates the position of the object to be simulated at the specific point of time (time=tₒ), X⁽ⁿ⁾ (tₒ) indicates an n^{th}-order differential coefficient, and n is a natural number.

The simulation unit 120 may simulate the object to be simulated with a precision recognized by the precision recognition unit 110. To this end, the simulation unit 120 may simplify a simulation process according to the recognized precision or may update the simulation result at a frequency corresponding to the recognized precision if the simulation process is repeated, as will be described in greater detail below.

The simulation unit 120 may simulate the object to be simulated using a simulation process obtained by simplifying the highest-precision simulation process according to the recognized precision. In a first example, it is assumed that a total of 3 objects M1, M2, and M3 are included in the image input through the input terminal IN1 and precisions A1, A2, and A3 respectively of the objects M1, M2, and M3 recognized by the precision recognition unit 110 have the relationship of A2>A3>A1. In this case, the simulation unit 120 may simulate the object M1 using the Euler Method, may simulate the object M2 using the Runge-Kutta 4th order Method, and may simulate the object M3 using the Improved Euler Method. The Euler Method typically means Taylor Series where n=1, the Improved Euler Method typically means Taylor Series where n=2, and the Runge-Kutta 4th order Method typically means Taylor Series where n=4.

When the simulation apparatus operates repetitively for an object to be simulated, the simulation result with respect to the object may be updated at a frequency corresponding to the recognized precision of the object. In a further example, it may be assumed that a total of 3 objects M4, M5, and M6 are included in the image input through the input terminal IN1 and precisions A4, A5, and A6 respectively of the objects M4, M5, and M6 recognized by the precision recognition unit 110 have the relationship of A5>A4>A6.

Here, the simulation result with respect to the object M4 may be updated a total of 3 times during “a time interval T between adjacent frames”. In other words, “h” may be T/3. More specifically, in order to simulate the object M4 included in a frame immediately following a frame at the specific point of time (time=tₒ), the simulation unit 120 may simulate the object M4 at time=tₒ+T/3 using information about the object M4 at the specific point of time (time=tₒ), simulate the object M4 at time=tₒ+2T/3 using information about the simulated object M4 at time=tₒ+T/3, and simulate the object M4 at time=tₒ+T using the simulated object M4 at time=tₒ+2T/3.

Similarly, the simulation result with respect to the object M5 may be updated a total of 5 times during “a time interval T between adjacent frames”. In other words, an updating period of M5 may be T/5. More specifically, in order to simulate the object M5 included in a frame immediately following a frame at the specific point of time (time=tₒ), the simulation unit 120 may simulate the object M5 at time=tₒ+T/5 using information about the object M5 at the specific point of time (time=tₒ), simulate the object M5 at time=tₒ+2T/5 using information about the simulated object M5 at time=tₒ+T/5, simulate the object M5 at time=tₒ+3T/5 using the simulated object M5 at time=tₒ+2T/5, simulate the object M5 at time=tₒ+4T/5 using the simulated object M5 at time=tₒ+3T/5, and simulate the object M5 at time=tₒ+T using the simulated object M5 at time=tₒ+4T/5.

In this way, as “h” is much less than “T”, the simulation unit 120 may simulate the objects M4 and M5 included in a frame immediately following a frame at the specific point of time (time=tₒ) with higher precision.

Likewise, the simulation result with respect to the object M6 may be updated once during “four intervals T between adjacent frames”. In other words, “h” may be 4T. More specifically, the simulation unit 120 may simulate the object M6 included in a frame at time=tₒ+T, which immediately follows a frame at the specific point of time (time=tₒ) using information about the object M6 included in the frame at the specific point of time (time=tₒ). Thereafter, the simulation unit 120 may simulate the object M6 included in the second frame at time=tₒ+2T from the frame at time=tₒ, using information about the M6 at time=tₒ instead of at time=tₒ+T. The simulation unit 120 then simulates the object M6 included in the third frame at time=tₒ+3T from the frame at time=tₒ, using information about the M6 at time=tₒ instead of at time=tₒ+2T. The simulation unit 120 then simulates the object M6 included in the fourth frame at time=tₒ+4T from the frame at time=tₒ, using information about the simulated M6 at time=tₒ+3T. In such a simulation, high precision generally cannot be expected for the simulation result with respect to the object M6 included in the second frame at time=tₒ+2T from the frame at time=tₒ and the simulation result with respect to the third frame at time=tₒ+3T from the frame at time=tₒ. As such, as the updating period of M6 is much greater than T, the simulation unit 120 is likely to simulate the object M6 with lower precision.

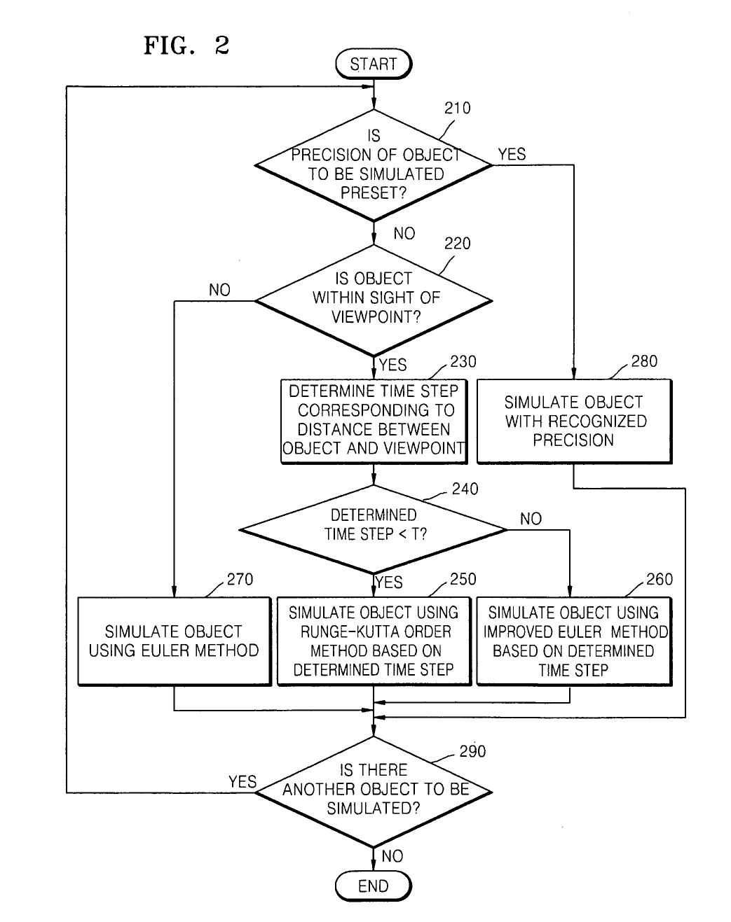

FIG. 2 illustrates a simulation method, according to an embodiment of the present invention. The simulation method may include, for example, operations 210 through 290 for efficiently using computing resources for simulation by simulating objects to be simulated at various precisions, noting that the described apparatus and method are mutually exclusive and should not be limited to the same.

Whether the precision of an object to be simulated is preset may be determined in operation 210, e.g., by the precision recognition unit 110.

If it is determined in operation 210 that the precision of the object is not preset, it may be determined whether the object is within the sight of a viewpoint in operation 220, e.g., by the precision recognition unit 110.

If it is determined in operation 220 that the object is within sight of the viewpoint, a time step corresponding to a distance between the object and the viewpoint may be determined, e.g., by the precision recognition unit 110. Here, the time step indicates an above-mentioned “h” and the determined time step is proportional to the distance between the object and the viewpoint.

It may be determined whether the time step determined in operation 230 is less than the above-mentioned T in operation 240. Although the time step is compared with T for convenience of explanation, it may also be compared with other values, e.g., 2T.

If it is determined in operation 240 that the time step is less than T, the precision the Runge-Kutta 4th order Method may be determined as a simulation process, and the object may be simulated using the Runge-Kutta 4th order Method based on the time step determined in operation 230 in operation 250, e.g., by the simulation unit 120.

On the contrary, if it is determined in operation 240 that the time step is equal to or greater than T, the Improved Euler Method may be determined as the simulation process, e.g., by the precision recognition unit 110 and the simulation unit 120 may simulate the object using the Improved Euler Method based on the time step determined in operation 230 in operation 260.

Meanwhile, if it is determined in operation 220 that the object is not within sight of the viewpoint, the Euler Method may be determined as the simulation process and 4T may be determined as the time step, and the object may be simulated using the Euler Method based on the determined time step (4T) in operation 270. Although 4T is determined as the time step for convenience of explanation, the time step is not limited to 4T and other value time steps may be used.

If it is determined in operation 210 that the precision of the object is preset, the preset recognition may be recognized and the simulation process may be determined, e.g., as the Runge-Kutta 4th order Method, and the time step as being, e.g., h=T/8, based on the recognized precision, and the object may be simulated using the determined simulation process (e.g., Runge-Kutta 4th order Method) based on the determined time step (e.g., h=T/8) in operation 280.

After operation 250, operation 260, operation 270, or operation 280, it may be determined whether another object to be simulated exists in a frame in operation 290, e.g., by the precision recognition unit 110. If so, the process returns to operation 210.

In addition to the above described embodiments, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as media carrying or including carrier waves, as well as elements of the Internet, for example. Thus, the medium may be such a defined and measurable structure including or carrying a signal or information, such as a device carrying a bitstream, for example, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

As described above, according to one or more embodiments of the present invention, by simulating objects various precisions, computing resources for simulation may be more efficiently used. More specifically, an object whose simulation result is of relatively little interest to a user is simulated with a lower precision than that of an object whose simulation result is of relatively great interest to the user, thereby allowing the efficient use of computing resources.

Furthermore, according to one or more embodiment of the present invention, low-precision simulation is applied to an object whose simulation result is not likely to dissatisfy the user even though it is inaccurate, and high-precision simulation is applied to the object whose simulation result is likely to satisfy the user if it is inaccurate. Thus, a user is unlikely to recognize a difference between results of a simulation performed by a conventional simulation apparatus, i.e., the results of simulating all objects at a high precision and results of a simulation according to embodiments of the present invention’, i.e., simulating objects at various precisions. Therefore, the quality of the result of simulation performed by a conventional simulation apparatus can be maintained to some extent without simulating all objects at a high precision, resulting in more efficient use of computer resources.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A simulation method comprising:
identifying a simulation precision that is determined based on an environmental context of an object or preset regarding the object; and
simulating the object with the identified precision.

2. The simulation method of claim 1, wherein the environmental context includes at least one of a distance between a viewpoint and the object and whether or not the object is within sight of the viewpoint.

3. The simulation method of claim 1, wherein the simulating comprises simulating the object using a simulation process obtained by simplifying a high-precision simulation process according to the identified precision.

4. The simulation method of claim 1, wherein a simulation result is updated at a frequency corresponding to the identified precision.

5. The simulation method of claim 3, wherein the simulation unit selectively simulates the object according to at least one of a Euler Method, a Runge-Kutta 4th Order method and an improved Euler method.

6. At least one medium comprising computer readable code to control at least one processing element in a computer to implement the method of claim 1.

7. A simulation apparatus comprising:
a precision recognition unit to identify a simulation precision that is determined based on an environmental context of an object or preset regarding the object; and
a simulation unit to simulate the object with the identified precision.

8. The simulation apparatus of claim 7, wherein the environmental context includes at least one of a distance between a viewpoint and the object and whether or not the object is within sight of the viewpoint.

9. The simulation apparatus of claim 7, wherein the simulation unit simulates the object using a simulation process obtained by simplifying a high-precision simulation process according to the identified precision.

10. The simulation apparatus of claim 7, wherein a simulation result is updated at a frequency corresponding to the identified precision.

11. The simulation apparatus of claim 7, further comprising a look-up table having a plurality of pre-determined precisions and wherein the precision recognition unit may search a corresponding precision in the look-up tabled based on the environmental context of the object.

12. The simulation apparatus of claim 9, wherein the simulation unit selectively simulates the object according to at least one of a Euler Method, a Runge-Kutta 4th Order method and an improved Euler method.

13. An apparatus simulating objects in an image, the apparatus comprising:
a precision recognition unit to identify a desired simulation precision of an object in the image from a plurality of predetermined simulation precisions based on an environmental context of the object; and
a simulation unit to simulate the object with a precision identified by the precision recognition unit.

14. The apparatus of claim 13, further comprising a look-up table having the plurality of pre-determined precisions and wherein the precision recognition unit may search a corresponding precision in the look-up tabled based on the determined environmental context.

15. The apparatus of claim 13, wherein the environmental context comprises at least one of:
a distance between the object to be simulated and a viewpoint; and
whether or not the object to be simulated is within sight of the viewpoint.

16. The apparatus of claim 13, wherein the simulation unit simulates the object using a simulation process obtained by simplifying a high-precision simulation process according to the identified precision.

17. The apparatus of claim 16, wherein the simulation unit selectively simulates the object according to at least one of a Euler Method, a Runge-Kutta 4th Order method and an improved Euler method.

18. The apparatus of claim 13, wherein as a distance between an object to be simulated and the viewpoint increases, the precision of the object may be set lower.
